(19) United States
(12) Patent Application Publication
(10) Pub. No.: US 2026/0142967 A1
(43) Pub. Date: May 21, 2026

(54) IOT DEVICE PASSWORD SHARING SYSTEM

(71) Applicant: MH HOLDINGS USA CORP., Newark, DE (US)

(72) Inventor: MING-HUNG CHEN, Taipei (TW)

(21) Appl. No.: 18/951,681

(22) Filed: Nov. 19, 2024

(51) Int. Cl. H04L 9/40; G16Y 40/50

(52) U.S. Cl. CPC H04L 63/083; G16Y 40/50

(57) ABSTRACT

An IoT device password sharing system comprises a cloud server, at least one first smart device, at least one second smart device and at least one smart lock, and is connected to the cloud server through an application software of the first smart device, thereby setting a password message for the smart lock remotely, and transmitting the password message to the second smart device through the cloud server, and the second smart device is capable of opening the password message through an application software thereof and sharing the received password message, thereby achieving an object of opening the smart lock.

### BACKGROUND OF THE INVENTION

### Field of Invention

The invention relates to a password sharing system for IoT devices, more particularly to a password sharing system that facilitates management and control of locks.

### Related Art

In the past, door locks could only be opened with keys. In order to improve security and provide convenience of use, many new door locks can be opened by sensing, scanning or entering a password. However, in terms of induction or scanning methods, most of the doors still need to be opened successfully after approaching the door lock through the so-called proximity card. In addition to being safer and faster than the key, the proximity card still needs to be carried by the user and has the risk of loss. In addition, by entering the password on the door lock, although the inconvenience of carrying a proximity card is eliminated, besides the time required to enter the password, users forgetting the password is a common problem. For hotels or landlords who own many objects, it is quite laborious and time-consuming to manage and control multiple door locks at the same time and to correctly allocate proximity cards or passwords to tenants or users of corresponding door locks. Therefore, how to improve the drawbacks and tackle the problems mentioned above is the technical difficulty that the inventor of the invention wants to solve.

### SUMMARY OF THE INVENTION

A main object of the invention is to provide an IoT device password sharing system composed of a cloud server, at least one first smart device, at least one second smart device and at least one smart lock, and connected to the cloud server through an application software of the first smart device, thereby setting a password message for the smart lock remotely, and transmitting the password message to the second smart device through the cloud server, and the second smart device is capable of opening the password message through an application software thereof and sharing the received password message, thereby achieving an object of opening the smart lock.

In order to achieve the above object: wherein the cloud server comprises an authentication module, a configuration module, a sharing module and a storage module.

In order to achieve the above object: wherein the first smart device can be either a computer, a smart phone or a tablet computer, and has functions of networking.

In order to achieve the above object: wherein the second smart device can be either a computer, a smart phone or a tablet computer, and has functions of networking.

In order to achieve the above object: wherein the smart lock comprises a data processing module and a wireless signal transceiver module, and is connected to the cloud server through the wireless signal transceiver module.

### BRIEF DESCRIPTION OF THE DRAWINGS

FIG. 1 is a block diagram of a system of the invention.

FIG. 2 is a first block diagram of a preferred embodiment of the invention.

FIG. 3 is a second block diagram of a preferred embodiment of the invention.

FIG. 4 is a schematic diagram of a preferred embodiment of the invention.

### DETAILED DESCRIPTION OF THE INVENTION

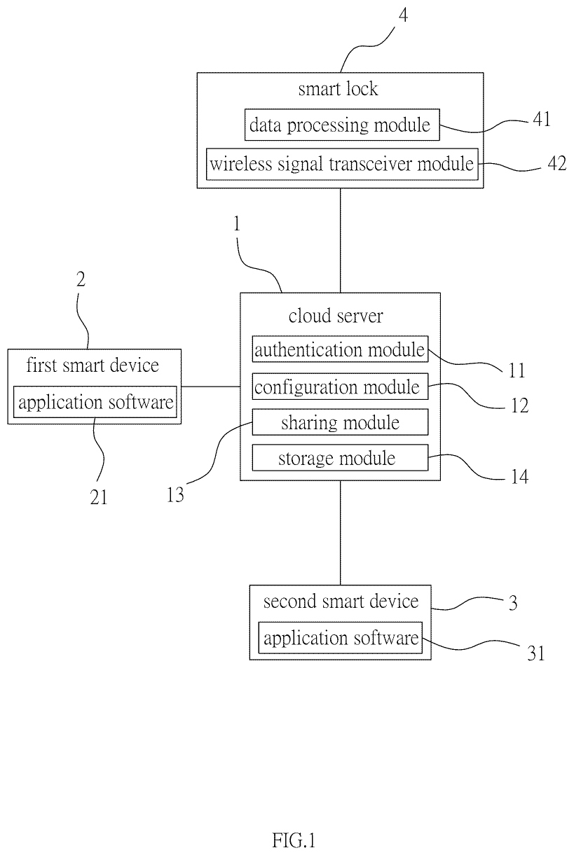

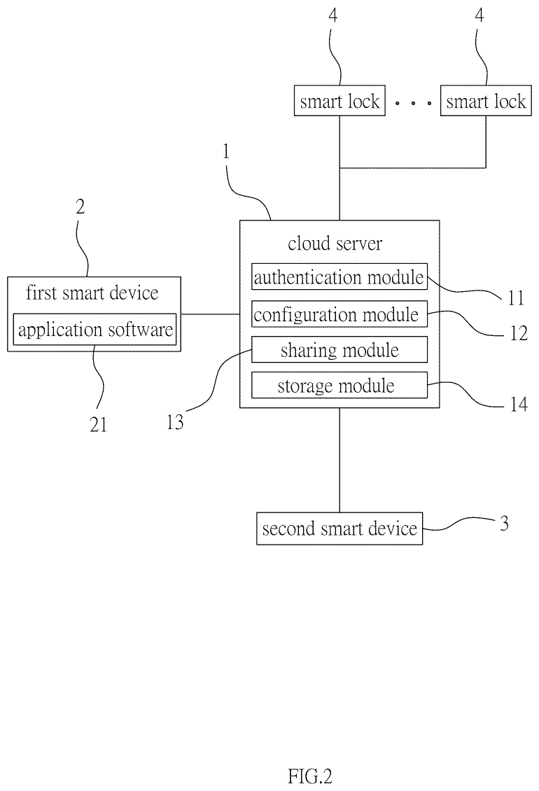

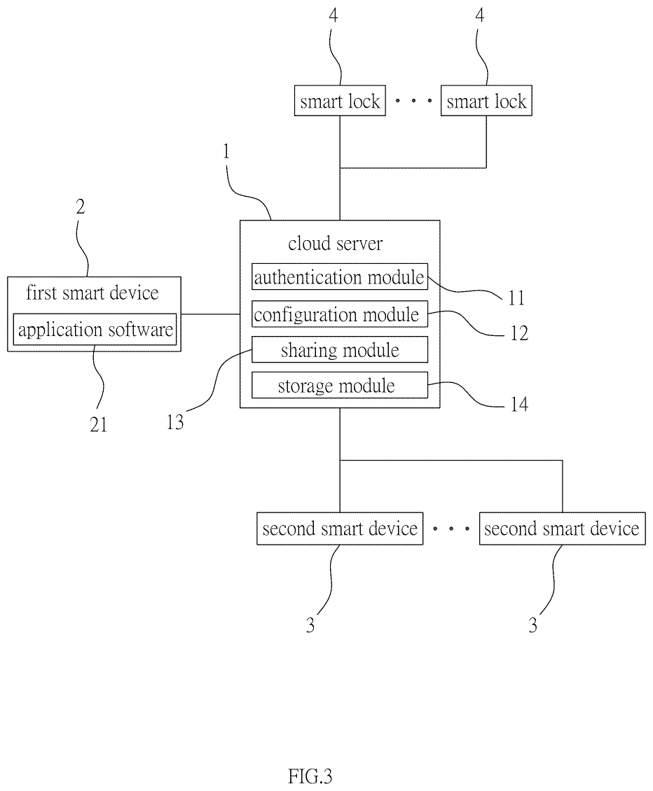

Please refer to FIGS. 1, 2, 3 and 4 for block diagrams and a schematic diagram of a system of preferred embodiments of the invention. It can be clearly seen from the figures that the invention mainly comprises:
a cloud server 1;
at least one first smart device 2 equipped with an application software 21 and connected to the cloud server 1;
at least one second smart device 3 equipped with an application software 31 and connected to the cloud server 1; and
at least one smart lock 4 connected to the cloud server 1.

Wherein the cloud server 1 comprises an authentication module 11, a configuration module 12, a sharing module 13 and a storage module 14.

Wherein the first smart device 2 can be either a computer, a smart phone or a tablet computer, and has functions of networking;

Wherein the second smart device 3 can be either a computer, a smart phone or a tablet computer, and has functions of networking;

Wherein the smart lock 4 comprises a data processing module 41 and a wireless signal transceiver module 42, and is connected to the cloud server 1 through the wireless signal transceiver module 42.

The first smart device 2 of the invention is mainly owned by hotels or landlords, while the second smart device 3 is held by lodgers or tenants. Firstly, the hotels or landlords connect to the cloud server 1 through the application software 21 equipped in the first smart device 2, and then authenticating an identity with the authentication module 11. After confirming the identity, the hotels or landlords can set a set of password message for the smart lock 4, and then send the password message to the second smart device 3 through the sharing module 13 of the cloud server 1. The lodgers or tenants can open the received password message through the application software 31 equipped in the second smart device 3, and the smart lock 4 can be opened immediately after receiving the password message through the cloud server 1.

Based on the above, when the lodgers or tenants use the application software 31 equipped in the second smart device 3, an identity must be authenticated through the authentication module 11 of the cloud server 1, that is, filling in basic data such as name, ID number, contact phone number, etc. After the hotels or landlords confirm an identity of the lodgers or tenants on the cloud server 1 through the application software 21 of the first smart device 2, the password message can then be sent to the second smart device 3 of the lodgers or tenants through the sharing module 13 of the cloud server 1. After the lodgers or tenants open the password message through the application software 31 of the second smart device 3, the password message is then sent to the smart lock 4 through the cloud server 1. The smart lock 4 can be opened immediately after determining that the password message is correct through the data processing module 41 thereof.

In addition, since the hotels or landlords hold many room objects, which are, the smart locks 4; therefore, after connecting to the cloud server 1 through the application software 21 of the first smart device 2, each of the smart locks 4 can be numbered or marked by the configuration module 12 of the cloud server 1, and then the password message corresponding to each of the smart locks 4 can be set, and finally the password message can be transmitted to the second smart device 3 of the lodgers or tenants corresponding to each of the smart locks 4 through the sharing module 13 of the cloud server 1.

In addition, in order to record a usage history of the lodger or tenant; or if the lodgers or tenants use the same smart lock 4, in order to facilitate management and security of the hotels or landlords, a record of opening the smart lock 4 will be stored in the storage module 14 of the cloud server 1. Of course, the password message and other values set by the hotels or landlords through the configuration module 12 are also stored in the storage module 14 of the cloud server 1.

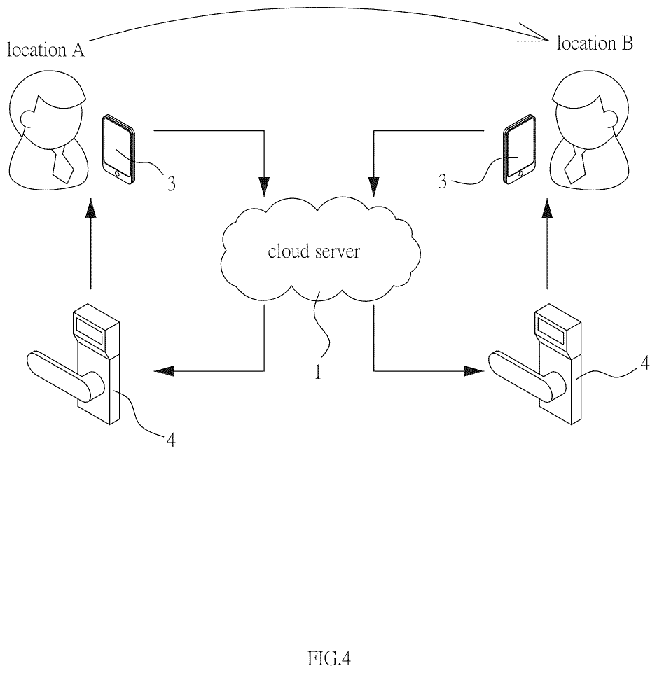

In addition, as shown in FIG. 4, since a user has authenticated an identity in the cloud server 1 through the second smart device 3 when using for the first time at location A, and obtained a permission to use the smart lock 4 at location A; therefore, when the user is located at location B and needs to use the smart lock 4 at location B, the hotels or landlords only need to grant the user permission to use the smart lock 4 at location B through the first smart device 2 from the cloud server 1, so that the user can use the smart lock 4 at location B without going through an authentication process again. This embodiment mainly illustrates that after a same user (lodger or tenant) performs a first authentication process through the second smart device 3, the hotels or landlords can grant the user permission to use the other smart locks 4. Therefore, when the user needs to use the smart locks 4 in other locations, the user can quickly obtain a permission to use.

In addition, since the second smart device 3 has functions of networking, and the smart lock 4 has the wireless signal transceiver module 42, the lodgers or tenants can directly send the password message to the smart lock 4 from the second smart device 3 after the second smart device 3 receives the password message. After the smart lock 4 receives the password message, the smart lock 4 can be opened immediately after determining that the password message is correct through the data processing module 41 thereof.

In addition, if the smart lock 4 is used by an individual user other than the hotels or landlords, and if the new smart lock 4 is added, the smart lock 4 can first be connected to the cloud server 1 through the application software 21 of the first smart device 2, and after authenticating an identity with the authentication module 11, the newly added smart lock 4 can be linked, so that the individual user can quickly manage and use the newly added smart lock 4.

In addition, if the individual user wants to give one of the smart locks 4 he or she possesses to others for temporary use, such as friends who live at the individual user's place temporarily or temporary cleaning staff, the smart lock 4 can first be connected to the cloud server 1 through the application software 21 of the first smart device 2, and then after authentication, a temporary password message is generated and shared with the second smart device 3 of the temporary resident friend or temporary cleaning staff, and the temporary resident friend or temporary cleaning staff can use the smart lock 4 through the temporarily generated password message. Since the time used by the temporary resident friend or temporary cleaning staff is not long or is for a predetermined time, the individual user can also set a time period in which the temporarily generated password message can be used. For example, if a cleaning time of the temporary cleaning staff is from 9 am to 11 am every Monday, the temporary password message can only be used during this time period, and the smart lock 4 cannot be opened even if the temporary password message is used during the rest of time.

Following the above, a sharing mode can also be used by the individual user's family members or children. In the same way, the smart lock 4 can first be connected to the cloud server 1 through the application software 21 of the first smart device 2, and then after authentication, connect to one of the smart locks 4, correspond the password message of the smart lock 4 to the other smart locks 4 to synchronize permissions of the other smart locks 4, and then provide the permissions to the individual user's family members or children. Through this sharing mode, the family members can or children can quickly open the other synchronized smart locks 4.

Summing up the above, compared with the various drawbacks and inconveniences of conventional door locks being opened through sensing, scanning or entering passwords, through special system designs of the cloud server 1, the first smart device 2, the second smart device 3 and the smart lock 4, the invention not only enables the hotels or landlords to remotely and quickly share a password of the smart lock 4 with the lodgers or tenants for use, but also can control the smart locks 4 at the same time.

The above-mentioned embodiments are used to illustrate one of the feasible preferred embodiments of the invention and are not intended to limit the scope of the invention. Any person having ordinary in the art can make changes and modifications without departing from the spirit and scope of the invention. Therefore, the scope of protection of the invention shall be determined by the appended claims.

What is claimed is:

1. An IoT device password sharing system comprising:
a cloud server;
at least one first smart device equipped with an application software and connected to the cloud server;
at least one second smart device equipped with an application software and connected to the cloud server; and
at least one smart lock connected to the cloud server; and
connected to the cloud server through the application software of the first smart device, thereby setting a password message for the smart lock remotely, and transmitting the password message to the second smart device through the cloud server, and the second smart device being capable of opening the password message through the application software thereof and sharing the received password message, thereby achieving an object of opening the smart lock.

2. The IoT device password sharing system as claimed in claim 1, wherein the cloud server comprises an authentication module, a configuration module, a sharing module and a storage module.

3. The IoT device password sharing system as claimed in claim 1, wherein the first smart device can be either a computer, a smart phone or a tablet computer, and has functions of networking.

4. The IoT device password sharing system as claimed in claim 1, wherein the second smart device can be either a computer, a smart phone or a tablet computer, and has functions of networking.

5. The IoT device password sharing system as claimed in claim 1, wherein the smart lock comprises a data processing module and a wireless signal transceiver module, and is connected to the cloud server through the wireless signal transceiver module.
